(19) United States
(12) Patent Application Publication
(10) Pub. No.: US 2013/0169406 A1
(43) Pub. Date: Jul. 4, 2013

(54) WIRELESS NETWORK FOR HOME AUTOMATION

(71) Applicants: Paolo Ferron, Oderzo (IT); Oscar Marchetto, Oderzo (IT)

(72) Inventors: Paolo Ferron, Oderzo (IT); Oscar Marchetto, Oderzo (IT)

(73) Assignee: NICE S.P.A, Oderzo (IT)

(21) Appl. No.: 13/814,014

(22) PCT Filed: Aug. 3, 2011
(86) PCT No.: PCT/IB11/53445

§ 371 Date: Feb. 4, 2013

(30) Foreign Application Priority Data
Aug. 5, 2010 (IT) VR2010A000163

(51) Int. Cl. H04W 72/08

(52) U.S. Cl. CPC H04W 72/08
USPC 340/2.7

(57) ABSTRACT

A transmission method is described between components belonging to a wireless network or system for home automation adapted to operate e.g. sliding or hinged gates, doors or garage doors, shutters, blinds, curtains or blinds in general. The components are network-configured and communicate with a wireless device. To improve quality communication a component according to prefixed criteria selects from a list of at least two predefined channels the communication channel to transmit on.

The invention relates to a wireless bidirectional communication network (e.g. radio) between devices for home automation, such as horizontal or vertical-movement closing systems (left-right), between two end-positions, such as sliding or swing gates, which we will refer to here as an example, doors or garage doors, shutters, blinds, curtains or blinds in general.

The systems to automate the movement of a gate are usually composed primarily of at least one electric gearmotor to move the gate, a control unit, and a set of other peripheral safety devices such as photocells, sensitive edges to pressure, warnings (buzzers or flashers) and control and management interfaces for the user, like keypads and/or display.

The cable connection between the devices is widely spread and used in most cases but is quite expensive to install, because one has to lay pipes or ducts for the passage of the cables with their masonry, small excavations and restoration works, spending lot of time in labor and materials.

The costs are very high, the risk of errors in the connections is high and maintenance control becomes uncomfortable and unfavorable in case of failure. It is understandable why efforts have been focused in the direction of eliminating the most of the wiring.

The cable connections generally have two different configurations.

In the first, each peripheral device has a specific connection terminal for two-wire cable both to the power supply and to the control unit, and it is not necessary to identify the device because it is unique and only of one type. E.g. the terminal of a flasher can not be connected to photocells.

In the second configuration a general peripheral device communicates to the central unit its address or ID code by deriving it from its setting of jumpers or dip-switches manually set. This is because several devices are connected to the control unit by a single pair of wires to a single terminal (see for example MI2002A001234 filed by the Applicant). Unfortunately, this addressing system is limited by the selector used (jumpers or DIP switches), has very few combinations and greatly limits the number and type of devices that the system can manage, partly because of the data traffic present.

Other systems eliminate some wiring by replacing them with wireless links, but the network architecture remains the same as the wired systems, wherein each device is stored in the control unit by a coding set by mechanical selectors (jumpers or DIP switches).

The implementation of a totally wireless system (communication and power supply) using known techniques and devices collides with high energy consumption of the same and, consequently, with the autonomy of the batteries that supply them. During a maneuver all the photocells (up to 6-8 pairs), the sensitive edges (up to 4), and in general all the peripheral safety devices must function without errors. Although less important, during the maneuver the control peripheral devices such as keyboards, digital transponder readers, key switches, etc. are active as well. These must work in coordination and with tight timing, which implies constraints of time and frequency/period of radio transmissions, and therefore of energy demand. With a direct application of known techniques, a totally wireless network meeting the requirements is not feasible.

The implementation of an automation system whose all components are wirelessly connected also has the problem of interference between systems close to one another. The safety of an automation system is of paramount importance, therefore the system must be immune to them as much as possible.

The main object of the invention is to provide a method and a plant or system or network that implements it, for the automation of sliding gates or swing gates, doors or garage doors, shutters, blinds, curtains or awnings generally available, in which all the peripheral devices have a wireless connection (e.g. radio) with the control unit and a stand-alone power supply system, and have high operating endurance of several years.

A further object is that the method/system be reliable and immune to radio interference.

A further object is that the method/system be simple and quick to install.

A further object is that the method/system have a good speed of response to user commands while ensuring long battery life.

These objects are achieved by a method and a component that implements it as defined in the appended claims, while the preferred variants of the invention are defined in dependent claims.

The features and advantages of the invention will be more evident by the exemplary description of an automation system, together with the attached drawing in which:

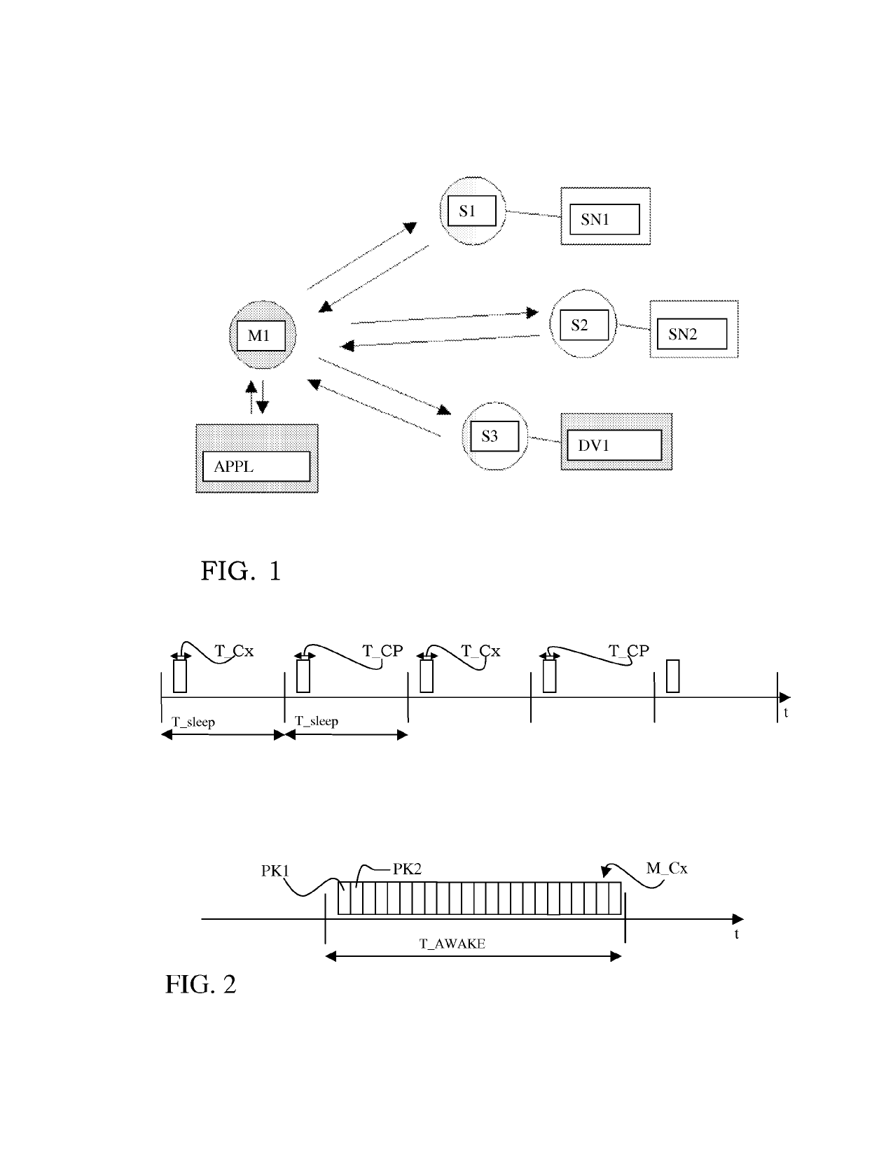

FIG. 1 shows a block diagram of a system according to the invention;

FIG. 2 shows a timeline of the system of FIG. 1 in a state of non-maneuver (door still);

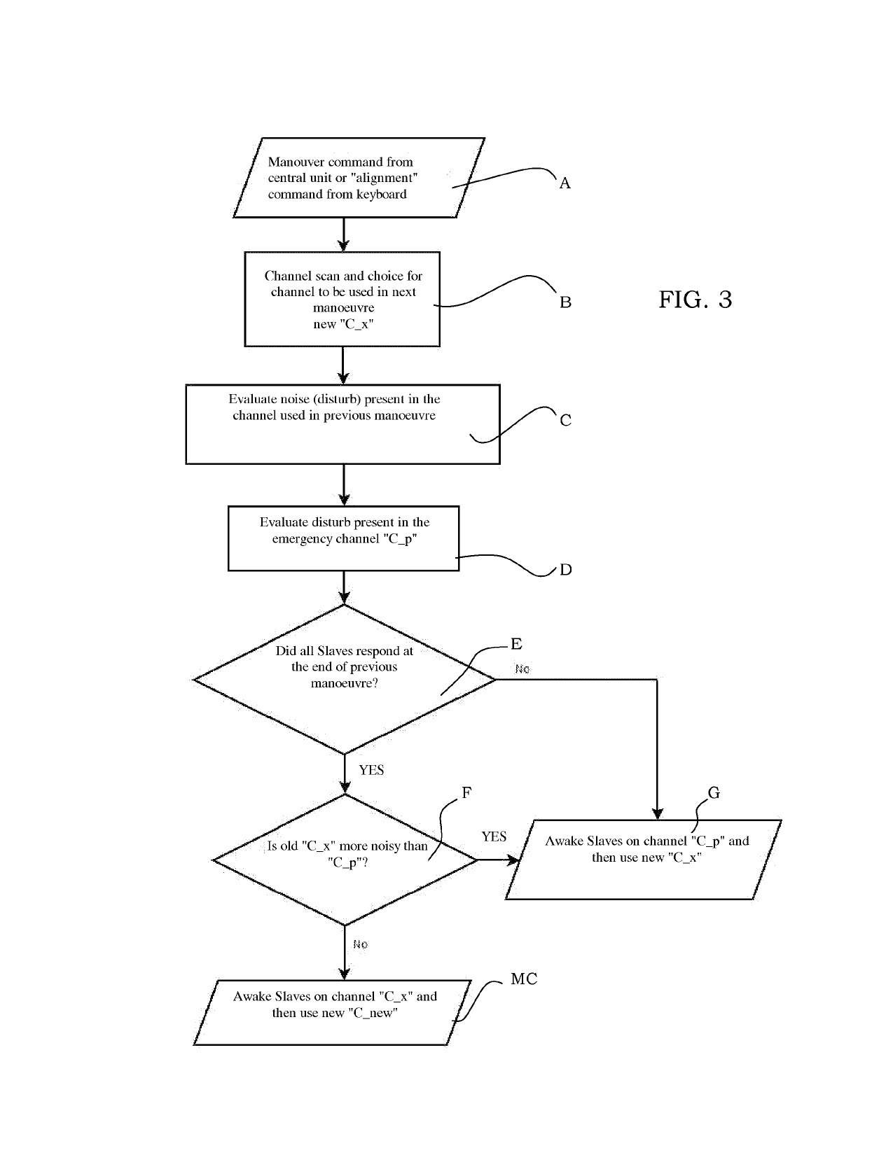

FIG. 3 shows a block diagram of a decision algorithm for selecting a radio transmission channel.

A home automation system according to the invention composed of traditional components is shown in FIG. 1.

One of the possible configurations of the network is star structure, with a Master node that forms the star center. See FIG. 1, which shows schematically a network NT1 that adopts the known Master/Slave transmission technique, with the star center that serves as the master node M1, and peripheral nodes that act as slave nodes, indicated with S1, S2, etc. All nodes, master and slave, can be completely integrated in the same component (electronic central units also integrated in the gearmotor, photocells, sensitive edges, flashing lights, card readers, keyboards, etc.) or can be made into a separate body and then associated. The network NT1 exhibits an electronic control unit as the master node M1 and at least one photocell or similar as peripheral devices or slave nodes S1, S2, etc.

Each slave has no cable connection with the outer world, and is equipped with a power-supply battery, preferably self-rechargeable by a solar module. It is understood that due to the wireless connection of each slave, it is very easy to place it in the environment without great building modifications and in short time.

Both the master M1 and the slaves S1, S2, etc. are each equipped with a microcontroller and a radio transmitter, not shown. The aim is to let the Master and the Slaves send and receive from/to each other coded control radio signals and data, indicated symbolically by the bi-directional arrows in FIG. 1. When we will describe below the operations performed by a Master or a Slave by attributing them for the sake of brevity directly to one of the two, we tacitly mean that the respective microcontroller executes program instructions and/or drives means or hardware devices adapted to perform the operation and/or the radio transmitter is controlled and/or the received signal is processed in order to perform these operations.

As it can be seen a master M1 communicates with the slaves S1, S2, which can act as interfaces to sensors SN1, SN2, etc. or other devices DV1, DV2, etc. The Master M1 can also communicate with an application block APPL. For reasons of compatibility with existing control units the Master node M1 can be connected to a control unit through the bus line, as an interface, making the pre-existing control unit (the application APPL) believe that the installed peripheral devices are devices connected by cable to the bus. This solution enables the creation of hybrid automations with cable and/or wireless devices. It will be indeed possible, by inserting into the bus the Master M1 interface, to add wireless members to already existing wired automations.

To improve network performance against radio interference of various kinds, and to allow several similar networks, even adjacent, to operate simultaneously, the system of the invention uses different transmission channels. E.g. 14 distinct channels (i.e. frequencies) can be used, all belonging to the same frequency band, for example the 868 MHz band. The channels constitute a predefined set of radio communication channels between which the Master can choose the best one to then command its use to the Slaves (process invisible to the user/operator).

Once the Master is powered, it performs a frequency scan to determine the best channels. After analyzing all the available channels, or only some of them, the master creates and maintains a statistical table of “channel quality” calculated on the basis of factors such as
information exchanged between adjacent Masters of different networks to share the collected data and information on the quality of the channels;
the information collected in the previous maneuver (for example, the number of “packets” sent but not received);
the scanning of all channels with the calculation of the relative S/N ratio, during the period of non-maneuver, until the best one is found when the maneuver is about to start. The master uses this information to constantly update “quality table”.

The quality table for the radio channels is transmittable, i.e. it can be shared between Masters belonging to different networks, on a common channel CP. The CP channel is common and fixed in all the networks and, as we shall see, is used in emergency cases and when information must be exchanged with a Master not in operation. This prevents the Masters and the Slaves of a network from tuning on channels occupied by other networks or disturbed, and improves the overall signal/noise ratio of the transmissions inside a formed network. It goes without saying that using a network without noise causes a lower power consumption, because lower power can be transmitted.

Once the channel quality table is created the master can proceed with the subsequent network installation/configuration operations, e.g.
when the master enters into Slave acquisition/configuration mode to configure the network, it first analyzes the channel quality table and among all the Master chooses as a communication channel with the slaves, to be stored in the network that is forming, the best channel free at that instant;
when a battery is inserted in the slaves, or an appropriate button is activated, the slaves transmit on all 14 channels until they receive a response from the Master through the channel just selected by the Master (the best channel). Upon receiving a positive response, the slaves listen/wait for receiving a confirmation that the network installation took place on the selected channel. Later, when the Master is ordered to finish the acquisition operations in order to verify that all the acquired slaves are actually working, it forwards a message to each of them. If each responds the operation is completed otherwise everything will be executed again.

The channel quality table is not static, but the invention provides means of dynamic adjustment and updating criteria. The environmental conditions of propagation may change over time. Some channels that were previously disturbed can become free and vice versa, that's why the quality table of channels can dynamically change on the basis, for example, of the following criteria:
the exchange of data between masters of adjacent networks;
the evaluation of the channels in the starting phase of the maneuver (see below);
assessment of the actual channel during the maneuver;
analysis of the channels at the end of the maneuver.

When the network is configured and operative it can work in two modes: the non-maneuver mode (door still or sleep mode) or in a maneuver mode (moving door).

In percentage, in terms of time, the network NT1 works more in a mode of non-maneuver, i.e. with the barrier/door stopped.

In non-maneuver the Master is inactive because it does not transmit to the Slaves, or it transmits with a very long period, while all the slave nodes are in sleep mode, which is a WOR (wake-on-radio) low power mode. See FIG. 2.

Each slave is listening on a radio listening-time window for equal times T_CX and T_CP to verify the presence respectively of a signal M_Cx from the Master on a predefined channel CP or a channel Cx of the predefined set. The times T_CP and T_CX are the time windows in which the slave is listening. During the time that runs between a listening and another, the Slave is in stand-by, and saves energy (all components are off except for an internal timer). The periods T_Cx and T_CP are equal, i.e. 300 μs, and repeat with a period T_sleep of e.g. 500 ms. Therefore the duty cycle (or working cycle) of the radio receiver is 0.3/500=0.0006.

The use of several channels makes the system more robust: in fact, the Master at his discretion may choose which of the channels is to be used in the next maneuver. The channel CP, which is preferably fixed and determined at the factory, never changes throughout the life of the system, serves as recovery channel and emergency channel to allow the Master node to try awakening the Slaves when it does not know if all of them are listening on the same channel or if the last channel Cx is disturbed. The channel Cx actually used in transreceiving is variable, and results the one chosen by the Master maneuver by maneuver (according to established criteria and previously described) because less disturbed (it can be changed at each maneuver).

The Slaves remain in the condition described (SLEEP mode) until they detect the signal M_Cx, coming from/sent by the Master, after which they go in active state out of the low-power state.

The message M_Cx is broadcast and is necessarily received by all slaves, or during the window T_Cx, T_CP. The message M_Cx contains the Master's address, which is implicitly the network address, consisting of numbered sub-messages PK1, PK2, which are in chronological order.

The Master sends the message M_Cx of duration T_AWAKE greater than 2*T_SLEEP (T_Cx or T_Cp), e.g. 1010 ms. In this way each slave node surely receives the message M_Cx.

The master transceives data signals with other masters of other near systems, to exchange useful information for the management and optimization of the network of each Master (as an example, they can exchange the list of the 14 channels used and their characteristics).

The state of maneuver is composed by the following phases:
selecting phase of the channel to be used by the Master;
awakening phase of the slaves;
phase of maneuver;
phase of end maneuver.

To go in the maneuver state the system operates as follows (see FIG. 3):
the Master receives a command from a user to move e.g. a gate (block A);
the Master analyzes all the available channels, or a part thereof, (block B), updating the statistical “channel quality” table determined by the factors described above, and determines the best channel;
The Master (block C) verifies, thanks to the scanning just performed, the disturbances on the channel Cx used in the previous maneuver and on the channel Cp (block D);
The Master (block E) evaluates whether at the end of the preceding maneuver all the slaves have replied to a query signal;
If (block E) all of the slaves replied, the Master evaluates (block F) if the channel Cx used in the previous maneuver is more disturbed than the channel Cp. If it is (block G) the Master sends a “wake-up” command to the Slaves on channel Cp, and then it will use the channel Cx selected during the scan done in block B. If it is not, the master sends the “wake-up” command on the channel Cx of the previous maneuver (block MC), and then it will use the channel Cx chosen during the scan done in block B.

The new chosen channel will be later communicated by the Master to the Slaves through the channel currently in use (Cx or Cp). Advantageously the Master can make a double effort to wake up the slaves, even attempting the wake-up on the channel Cp (emergency channel) after failing the first attempt on the channel Cx.

On the other hand, the channel CP is used as an emergency channel, i.e. probably very scarcely. Therefore, during the non-maneuver it has low probability of collision (interference from other transmitters).

All this prevents the master and the slave of a network from tuning on channels engaged by other networks, and improves the overall signal/noise ratio of transmissions in the network.

The master-slave topology of the network is an advantageous form because it simplifies control, but the invention also applies to a different network, e.g. a Token-ring topology.

1. Transmission method between components belonging to a wireless network or system for home automation adapted to operate e.g. sliding or hinged gates, doors or garage doors, shutters, blinds, curtains or blinds in general, wherein the components are network-configured and communicate with wireless means,
wherein
a component according to prefixed criteria selects from a list of at least two predefined channels the communication channel to transmit on.

2. Method according to claim 1, wherein the component scans all the predefined channels to analyze the transmission quality of each.

3. Method according to claim 1, wherein said component creates and updates a quality ranking for the channels of the list and, based on it, selects the future transmission channel.

4. Method according to claim 1, wherein said component exchanges with other components of the system or network, and/or external to it, its quality ranking for the channels.

5. Method according to claim 3, wherein the component performs an update of the quality ranking before each maneuver.

6. Method according to claim 1, wherein the list of channels comprises a predetermined fixed channel common to all components.

7. Method according to claim 1, wherein only one component among all performs the transmission channel selection and commands to the other components to use the selected channel.

8. Component belonging to a home automation wireless system adapted to operate e.g. sliding gates or swing gates, wherein the component is network-configured and communicates by wireless means, characterized by being configured to select according to prefixed criteria from a list of at least two predefined channels the communication channel to transmit on.

9. Component according to claim 8, wherein the component is configured to scan all or part of the predefined channels to analyze their transmission quality, and to create and update a quality ranking for the channels on the list used to select the future transmission channel.

10. Component according to claim 8, configured to exchange with other components of the system, and/or external to it, its quality ranking for the channels.

11. Method according to claim 2, wherein said component creates and updates a quality ranking for the channels of the list and, based on it, selects the future transmission channel.

12. Method according to 2, wherein said component exchanges with other components of the system or network, and/or external to it, its quality ranking for the channels.

13. Method according to 3, wherein said component exchanges with other components of the system or network, and/or external to it, its quality ranking for the channels.

14. Method according to claim 4, wherein the component performs an update of the quality ranking before each maneuver.

15. Method according to claim 2, wherein the list of channels comprises a predetermined fixed channel common to all components.

16. Method according to claim 3, wherein the list of channels comprises a predetermined fixed channel common to all components.

17. Method according to claim 4, wherein the list of channels comprises a predetermined fixed channel common to all components.

18. Method according to claim 5, wherein the list of channels comprises a predetermined fixed channel common to all components.

19. Method according to claim 2, wherein only one component among all performs the transmission channel selection and commands to the other components to use the selected channel.

20. Method according to claim 3, wherein only one component among all performs the transmission channel selection and commands to the other components to use the selected channel.
